(19) United States
(12) Patent Application Publication
(10) Pub. No.: US 2024/0228145 A1
(43) Pub. Date: Jul. 11, 2024

(54) FILM PACKAGING BAG WITH CONTENT

(71) Applicant: ORIHIRO Engineering Co., Ltd., Tomioka-shi, Gunma (JP)

(72) Inventor: Orihiro Tsuruta, Tomioka-shi, Gunma (JP)

(73) Assignee: ORIHIRO Engineering Co., Ltd., Tomioka-shi, Gunma (JP)

(21) Appl. No.: 18/561,597

(22) PCT Filed: Apr. 28, 2022
(86) PCT No.: PCT/JP2022/019305

§ 371 Date: Nov. 16, 2023

(30) Foreign Application Priority Data
Jun. 24, 2021 (JP) 2021-104524

(51) Int. Cl. B65D 75/58; A23G 3/48; B65D 75/12

(52) U.S. Cl. CPC B65D 75/5855; A23G 3/48; B65D 75/12; B65D 75/5866

(57) ABSTRACT

A packaging bag with contents obtained by filling a film packaging bag with a fluid and sealing the film packaging bag comprises: an accommodating portion in which the fluid is sealed; a pair of side seals) which seal both ends in a lateral direction of the film packaging bag; and a top seal which seals an upper end side in a vertical direction of the film packaging bag. The top seal has a pair of strong seal portions which connect to each of the side seals and form a narrow accommodating portion communicating with the accommodating portion, and a weak seal portion which is disposed in close contact with an upper edge of each of the strong seal portions and seals the upper end side of the narrow accommodating portion. An opening where the narrow accommodating portion is exposed is formed by peeling off the weak seal portion.

### TECHNICAL FIELD

The present invention relates to a film packaging bag with contents in which a fluid is filled.

### BACKGROUND ART

A film packaging bag is manufactured by heat-welding one or two (double) sheets of laminated film in a vertical direction and a lateral direction into a bag shape and then cutting the bag from the laminated film. The film packaging bag is used for automatic packaging for foods, medicals, and the like.

Patent Literature 1 discloses a bagged jelly food which is obtained by sealing a bite-size jelly in a film packaging bag. Such a bagged jelly food is easy to hold, and the jelly can be easily pushed out of the opened bag.

### CITATION LIST

### Patent Literature

Patent Literature 1: International Publication No. WO2018/198875

### SUMMARY OF INVENTION

### Technical Problem

For a bagged jelly food, an upper end (cut-off piece) of a film packaging bag is cut off so as to form an opening, and jelly is pushed out of this opening. At this time, the jelly is brought into contact with a cut surface of the laminated film.

Here, since an adhesive and printing ink are used for the laminated film, there is a risk that an extremely slight amount of chemical substance is exposed to the cut surface (opening) of the laminated film so that the chemical substance is mixed in the jelly.

There is a growing worldwide need to ensure food safety by eliminating contact and contamination of food with harmful chemical substances. Laws and regulations related to the film packaging bags are discussed and enacted in many countries, and industrial organizations for printing ink and the like are imposing voluntary restrictions. Moreover, the use of toluene-free film and the like for the laminated film has also been considered, but this has not been brought into practical use yet.

Thus, there is a need for a film packaging bag having a new type of opening that allows the film packaging bag to be opened without cutting the laminated film.

Since the bagged jelly food is excellent in portability, it is often brought to outdoors or the like and opened. Thus, dusts, bacteria (molds, germs and viruses), and the like can easily adhere to a surface of the film packaging bag.

Then, consumers may hold the area around the opening of the film packaging bag in their mouth and put the jelly directly into the mouth. As a result, there is a risk that bacteria (pathogens) adhering around the opening enter the consumers' body and harm the consumers' health.

Moreover, the cut-off piece of the film package bag which was cut off when opening the bagged jelly food has about a size of a fingernail, so it can be easily scattered as plastic waste. Therefore, the cut-off pieces may turn into microplastic and cause marine pollution.

The present invention has been made in view of the problem as described above and has an object to propose a film packaging bag with contents on which a hygienic opening can be formed without cutting off a part of the bag.

### Solution to Problem

In order to solve the aforementioned problem, the present invention proposes the following means.

A pillow packaging bag with contents according to an embodiment of the present invention is a packaging bag with contents obtained by filling a film packaging bag with a fluid and sealing the film packaging bag. Characteristically, the bag includes: an accommodating portion in which the fluid is sealed; a pair of side seals which seal both ends in a lateral direction of the film packaging bag; and a top seal which seals an upper end side in a vertical direction of the film packaging bag, the top seal has a pair of strong seal portions which connect to each of the side seals and form a narrow accommodating portion communicating with the accommodating portion, and a weak seal portion which is disposed in close contact with an upper edge of each of the strong seal portions and seals an upper end side of the narrow accommodating portion, and an opening where the narrow accommodating portion is exposed is formed by peeling off the weak seal portion.

Characteristically, the weak seal portion has a concave portion recessed toward an upper end side with respect to the strong seal portions, on a lower edge of a sealing part which seals the narrow accommodating portion.

Characteristically, a seal width of the weak seal portion is constant over an entire length in the lateral direction.

Characteristically, the weak seal portion has a peeling starting portion, which is a starting point of peeling.

Characteristically, the peeling starting portion has a symmetric shape in the lateral direction with respect to the narrow accommodating portion.

Characteristically, the peeling starting portion is also provided on both side parts of the sealing part.

Characteristically, a pair of protruding pieces are provided which consist of a pair of films extending from the weak seal portion and are pinched when the weak seal portion is peeled off.

Characteristically, the pair of protruding pieces have a symmetric shape in the lateral direction with respect to the narrow accommodating portion.

Characteristically, the pair of protruding pieces have parts not overlapping each other even when they are in close contact.

Characteristically, the strong seal portions form a leading-out portion with a gradually narrowing inner width on the upper end side of the accommodating portion.

Characteristically, the opening is formed at a center of the film packaging bag in the lateral direction.

Characteristically, the fluid is a gel-like confectionery.

Characteristically, the gel-like confectionery is a konjac-containing jelly.

### Advantageous Effects of Invention

According to the film packaging bag with the contents of the present invention, the opening can be formed without cutting off a part of the bag. Moreover, since the area around the opening is not exposed until the opening is formed, a hygienic opening to which germs do not adhere and which can be held in the mouth can be formed.

Thus, the film packaging bag with the contents having a safe and hygienic opening which can avoid intrusion of harmful chemical substances or pathogens into a human body can be provided.

### BRIEF DESCRIPTION OF THE DRAWINGS

FIG. 1 is a front view illustrating a bagged jelly food 1 according to an embodiment of the present invention.

FIG. 2 is an enlarged view illustrating a top seal 22.

FIG. 3 is a plan view illustrating a state where an opening 18 is formed.

FIG. 4 is a view illustrating a state where a konjac-containing jelly 5 is pushed out.

FIG. 5 is a view illustrating a state where a consumer holds an opening 18 in a mouth.

FIG. 6 are partially enlarged front views illustrating variations (notches 31 to 33) of a protruding piece 30.

FIG. 7 are partially enlarged front views illustrating variations (peeling starting portions 41 to 43) of a peeling starting portion.

FIG. 8 are partially enlarged front views illustrating a variation (peeling starting portion 44) of the peeling starting portion and a variation (concave portion 47) of a concave portion.

### DESCRIPTION OF EMBODIMENTS

Now, a bagged jelly food 1 according to an embodiment of the present invention will be described.

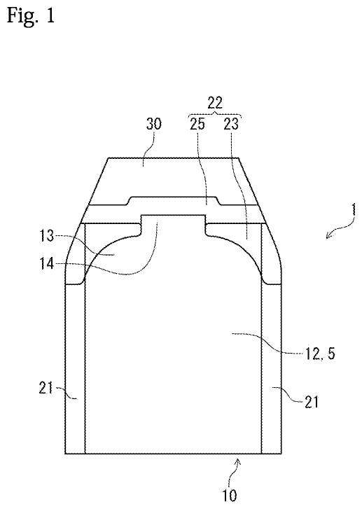

FIG. 1 is a front view illustrating the bagged jelly food 1 according to the embodiment of the present invention.

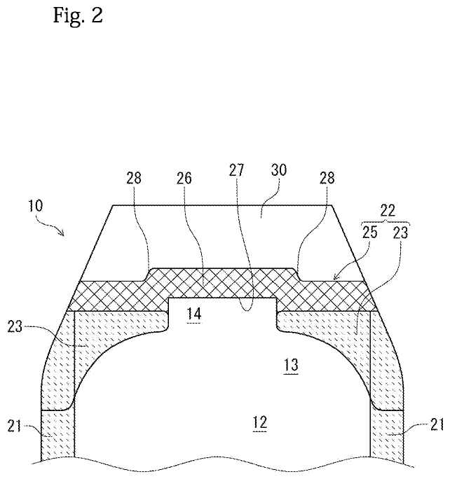

FIG. 2 is an enlarged view illustrating a top seal 22. A hatched portion in FIG. 2 indicates a heat-welded (heat-sealed) portion.

In the bagged jelly food 1, an up-down direction in FIG. 1 is called a “vertical direction”. In the vertical direction, an end portion side in which an opening 18 is formed is called an “upper side” or “upper end side”, and an opposite end portion side is called a “lower side” or “lower end side”.

A left-right direction in FIG. 1 is called a “lateral direction”. A depth direction in FIG. 1 is called a “front-back direction” or “thickness direction”.

The bagged jelly food (packaging bag with contents) 1 includes a packaging bag 10 made of a resin film F and a konjac-containing jelly 5 filled and sealed in this packaging bag 10.

The konjac-containing jelly (content, fluid material, gel-like confectionery) 5 is made by solidifying a jelly solution containing a gelling agent by an action of the gelling agent similarly to an ordinary jelly.

The konjac-containing jelly 5 is characterized by containing konjac refined powder in the jelly solution. The konjac-containing jelly 5 may further contain arbitrary materials as long as at least the gelling agent and the konjac refined powder are contained. The konjac-containing jelly 5 has unique chewiness with high elasticity by containing the konjac refined powder.

The packaging bag 10 (film packaging bag) is a rectangular bag body called a three-sided bag and is formed by heat-welding a band-shaped film F.

The packaging bag 10 is a bag body having easy openability. The easy openability is also called easy peel openability. In other words, the packaging bag 10 has the ability that allows an opening to be easily formed by hand when opening.

The film F is a laminated film in which a high-strength film such as nylon and polyester is laminated. The film F has a seal layer on an inner surface. A packaging bag having the open-easiness can be formed by using an easy peel resin as the seal layer.

The packaging bag 10 includes an accommodating portion 12, a pair of side seals 21, a top seal 22, and the like.

The accommodating portion 12 is a space formed by a pair of the opposing films F (non-seal portion not heat-welded), and is filled with konjac-containing jelly 5 and sealed.

The side seals 21 are parts formed by linearly heat-welding both edges (both ends) of the packaging bag 10 in the lateral direction over the entire length in the vertical direction. The side seal 21 has a band shape with a seal width of, for example, 5 mm.

The top seal 22 is a part formed by heat-welding the upper end side of the packaging bag 10 in the vertical direction over the entire length in the lateral direction. The opening 18 is formed on a part of this top seal 22. The top seal 22 is disposed on a lower side with respect to the upper end (upper edge) of the packaging bag 10. The top seal 22 is disposed approximately 10 mm below the upper end of the packaging bag 10.

On an upper side of the top seal 22, a pair of films F not heat-welded (protruding pieces 30 described later) are disposed to face each other.

The top seal 22 includes a pair of strong seal portions 23 and a weak seal portion 25.

The strong seal portions 23 and the weak seal portion 25 have different heat-seal strengths (see JIS Z 0238:1995 Heat-seal Strength Test of Bag).

For example, by adjusting a heating temperature, heating time, and the like to heat-weld the film F, the strong seal portions 23 and the weak seal portion 25 can be formed distinguishably.

The weak seal portions 25 may be formed by interposing a band-shaped weak-seal forming film (not shown) between a pair of the films F and heat-welding them similarly to the strong seal portion 23. By sandwiching the weak-seal forming film by the pair of films F and heat-welding them, the heat-seal strength of a region with the weak-seal forming film can be lowered (the weak seal portion 25 can be formed). The use of the weak-seal forming film has the advantage of eliminating the need for temperature adjustment when heat-welding the pair of films F.

The strong seal portion 23 has the heat-seal strength set to 20 [N/15 mm] or more. In particular, the heat-seal strength of the strong seal portion 23 is preferably 33 [N/15 mm] or more. Since the strong seal portion 23 has the heat-seal strength at 20 [N/15 mm] or more, it is difficult to break (peel off) it by human power. In other words, the pair of films F bonded together by the strong seal portion 23 will not be peeled off by human power.

On the other hand, the weak seal portion 25 has the heat-seal strength set to less than 10 [N/15 mm]. In particular, the heat-seal strength of the weak seal portion 25 is preferably 3 to 7 [N/15 mm]. Since the weak seal portion 25 has the heat-seal strength less than 10 [N/15 mm], it can be broken (peeled off) by human power. In other words, the pair of films F bonded together by the weak seal portion 25 may be peeled by human power.

The strong seal portion 23 and the weak seal portion 25 have the same or higher compression strength (see JIS Z 0238: 1995 Compression Strength Test).

A weight of the bagged jelly food 1 is about 20 g. Even when subjected to a compressive load of about 300 N for 60 seconds or more, the strong seal portion 23 and the weak seal portion 25 are not broken (peeled off).

Thus, even if the consumer presses a lower part of the packaging bag 10, there is no risk that the strong seal portion 23 and the weak seal portion 25 are broken. Therefore, there is no risk that the konjac-containing jelly 5 spouts out of the packaging bag 10.

The pair of strong seal portions 23 are disposed to connect to upper parts of the left and right side seals 21, respectively, and to protrude toward the center in the width direction. The pair of strong seal portions 23 have a symmetric shape with respect to the center in the width direction. The strong seal portions 23 have upper edges formed in parallel along the width direction. The upper edges of the strong seal portions 23 are disposed on the same straight line.

The strong seal portion 23 is formed in such a shape that a lower edge is recessed in an arcuate shape toward the upper end side. As a result, the pair of strong seal portions 23 form a leading-out portion 13 with a gradually narrowing inner width on the upper end side of the accommodating portion 12.

The pair of strong seal portions 23 are disposed with a distance of approximately 15 to 20 mm between them at the center in the width direction. As a result, the pair of strong seal portions 23 form the narrow accommodating portion 14 communicating with the accommodating portion 12 (leading-out portion 13).

The weak seal portion 25 is disposed in close contact with the upper side of the pair of strong seal portions 23. The weak seal portion 25 is formed linearly over the entire length in the lateral direction. The weak seal portion 25 has a band shape with a seal width of, for example, 5 mm. The weak seal portion 25 is formed so as to have a constant seal width over the entire length in the lateral direction. It is to prevent the weak seal portion 25 from being unexpectedly peeled off.

Left and right side parts of the weak seal portion 25 are connected to the pair of strong seal portions 23, respectively, and a center part thereof (sealed part 26) is spanned between the pair of strong seal portions 23. In other words, the sealed part 26 of the weak seal portion 25 is disposed so as to close the upper side of a gap between the strong seal portions 23. As a result, the weak seal portion 25 (sealed part 26) seals the narrow accommodating portion 14.

On the lower edge of the sealed part 26 of the weak seal portion 25, a concave portion 27 recessed toward the upper end side is provided. The concave portion 27 is provided at a position corresponding to the narrow accommodating portion 14.

The concave portion 27 has a depth of, for example, 1 mm from the lower edge to the upper end side of each of the strong seal portions 23, and the same width as the width of the narrow accommodating portion 14. The concave portion 27 is formed to have a shape corresponding to the upper edge of the sealed part 26 (profile lines thereof are parallel).

This concave portion 27 serves as the opening 18 when peeling the weak seal portion 25 (sealed part 26) off. By providing the concave portion 27 on the sealed part 26, the opening 18 is reliably opened when the weak seal portion 25 is peeled off, and the narrow accommodating portion 14 is exposed.

Since the concave portion 27 is provided on the lower edge of the sealed part 26, the sealed part 26 has a shape with an upper edge thereof protruding toward the upper end side by approximately 1 mm, for example. It is to make the seal width of the weak seal portion 25 constant.

Since the weak seal portion 25 is in close contact with the upper edge of the strong seal portions 23, it is not necessarily easy to completely peel off the weak seal portion 25. In other words, the lower edge of the weak seal portion 25 may remain welded. Thus, if the concave portion 27 is not present in the sealed part 26, the sealed part 26 (weak seal portion 25) remains on the upper end side of the narrow accommodating portion 14 without being peeled off so that the opening 18 is not formed and the narrow accommodating portion 14 cannot be exposed. If the consumer crushes the lower part of the packaging bag 10 in this state, the lower edge of the sealed part 26 remaining without being peeled off may be suddenly broken so that the konjac-containing jelly 5 spouts out of the opening 18.

Thus, concave portion 27 on the sealed part 26 is provided for allowing the opening 18 to be formed even if the weak seal portion 25 cannot be completely peeled off.

The sealed part 26 of the weak seal portion 25 is provided with a peeling starting portions 28 having a partially angular upper edge. The peeling starting portions 28 are disposed one each on the left and right sides of the sealed part 26. In other words, the peeling starting portions 28 have a symmetric shape in the lateral direction (left-right) with respect to the narrow accommodating portion 14.

The peeling starting portions 28 concentrate stress and makes it easier to peel off the weak seal portion 25 when forming the opening 18. In other words, the peeling starting portions 28 become starting points of the peeling of the weak seal portion 25.

Moreover, the packaging bag 10 includes a pair of protruding pieces 30. The pair of protruding pieces 30 are parts pinched by fingers of both hands, respectively, when peeling off the weak seal portion 25 to form the opening 18.

The pair of protruding pieces 30 consist of a pair of the films F extending from the weak seal portion 25 of the top seal 22 to the upper end side. In other words, the protruding pieces 30 are the pair of films F disposed to face each other and are non-seal portions disposed on the upper end side of the weak seal portion 25.

When the consumer pinches the pair of protruding pieces 30 with the fingers of both hands, respectively, and pulls each of the protruding pieces 30 in the separating direction (thickness direction), the weak seal portion 25 can be peeled.

The protruding pieces 30 are formed into a symmetric shape in the lateral direction (left-right) with respect to the narrow accommodating portion 14 (opening 18). That is to facilitate efficient transmission of a tensile force to the weak seal portion 25 when the consumer pulls the protruding pieces 30 in a direction of separating them. In other words, the protruding pieces 30 are configured such that even children or elderlies can reliably peel off the weak seal portion 25 and open the packaging bag 10 (form the opening 18).

In other words, if the protruding pieces 30 have an asymmetric shape, the tensile force is transmitted to the weak seal portion 25 unevenly, which makes the peeling off of the weak strong portion 25 difficult.

The pair of protruding pieces 30 do not need to have the same shape. The protruding pieces 30 may be in close contact with each other and be difficult to pinch by fingers. In order to peel (separate) the protruding pieces 30 in close contact, the shape of a part of each protruding piece 30 may be made different.

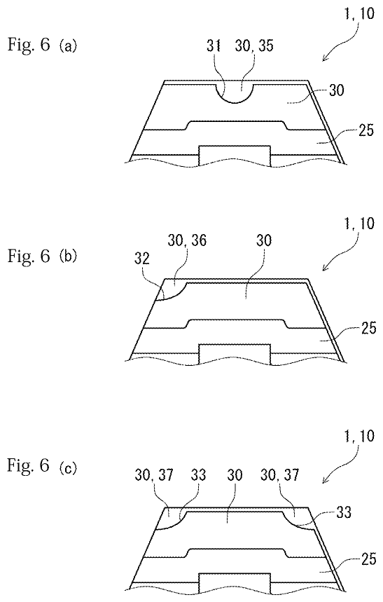

For example, the protruding piece 30 on a rear side is formed having a shape protruding toward the upper end side with respect to the protruding piece 30 on a front side. In other words, the protruding pieces 30 may be so configured that the upper end of the protruding piece 30 on the rear side sticks over the protruding piece 30 on the front side when overlapping them. As described above, the pair of protruding pieces 30 are provided with a part in close contact but not overlapping with each other (see FIG. 6). As a result, even if the protruding pieces 30 are in close contact with each other, the protruding pieces 30 can be easily separated from each other. Therefore, the consumers can open the packaging bag 10 without any irritation.

The bagged jelly food 1 is manufactured as follows, for example.

First, similarly to a case where an ordinary konjac-containing jelly is made, a konjac-containing jelly solution containing a gelling agent and konjac powders is prepared. In this konjac-containing jelly solution, saccharides, fruit juice, flavors, an acidifier, a food color, and the like can be added as necessary in addition to the gelling agent and the konjac powder.

Then, the prepared konjac-containing jelly solution is heat-sterilized. The heat-sterilization can be performed by any method such as use of a tube-type heat sterilizer. Sterilization conditions can be, for example, at 120 to 140° C. for about 3 minutes.

The sterilized konjac-containing jelly solution is cooled by a cooling apparatus to about 60 to 70° C., and then filled and packaged by using a vertical filling/packaging machine. The vertical filing/packaging machine preferably achieves aseptic filling/packaging for packaging under an aseptic environment by using sterilized contents and sterilized packaging materials.

In a vertical filling/packaging machine, a film folding step, a top seal forming step, a design-cut step, a first side seal step, a filling step, a second side seal step, and separation step are performed.

In the film folding step, a sheet of the film F is folded double.

In the top seal forming step, first, one sheet of the film F is heat-welded so as to form the strong seal portions 23. Then, the weak seal portion 25 is formed so as to be brought into close contact with the strong seal portions 23.

In the design-cut step, an end portion side of one sheet of the film F is cut so as to form the pair of protruding pieces 30.

In the first side seal step and the second side seal step, the side seals 21 are formed, respectively.

In the filling step, the packaging bag 10 is fully filled with a konjac-containing jelly solution.

Lastly, in the separating step, the side seal 21 is divided vertically, and the packing bag 10 is cut off.

After filling/packaging, the packaged konjac-containing jelly solution is cooled to 25° C. or below and solidified. As a result, the bagged jelly food 1 in which the konjac-containing jelly 5 is filled and sealed in the packaging bag 10 can be obtained.

In this bagged jelly food 1, since the konjac-containing jelly 5 is solidified with the packaging bag 10, the konjac-containing jelly 5 is present as one mass having a shape substantially equal to the shape of the accommodating portion 12.

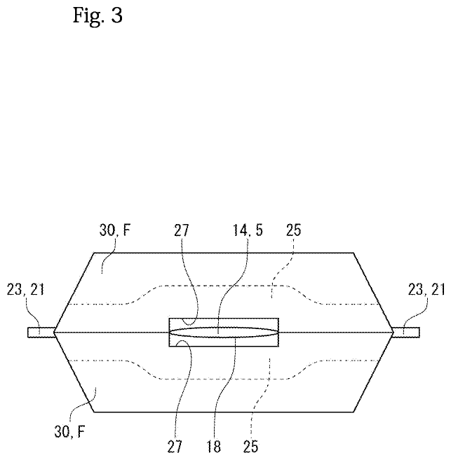

FIG. 3 is a plan view illustrating a state where an opening 18 is formed.

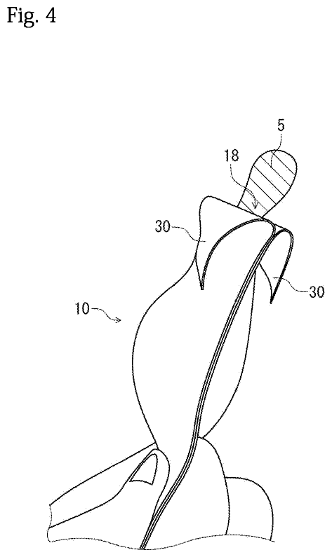

FIG. 4 is a view illustrating a state where the konjac-containing jelly 5 is pushed out.

In the bagged jelly food 1, the konjac-containing jelly 5 sealed in the packaging bag 10 can be eaten as follows.

The consumer first pinches the pair of protruding pieces 30 with the thumb and the forefinger of both hands, respectively. Then, the consumer pulls the pair of protruding pieces 30 in opposing directions (a forward direction and a rearward direction of the packaging bag 10).

This tensile force concentrates on the peeling starting portion 28 of the weak seal portion 25. As a result, with the peeling starting portion 28 as a starting point, the weak seal portion 25 begins to be peeled off. The weak seal portion 25 is gradually peeled off toward a lower end side. Then, when the peeling reaches the concave portion 27, the narrow accommodating portion 14 begins to be exposed. In other words, the opening 18 is formed on the packaging bag 10.

Since the peeling starting portion 28 is provided in the weak seal portion 25, even children or elderlies can reliably peel off the weak seal portion 25. Moreover, since the concave portion 27 is provided in the weak seal portion 25, even if the weak seal portion 25 cannot be completely peeled, the opening 18 can be formed reliably.

Then, the consumer crushes the lower part (accommodating portion 12) of the packaging bag 10. When the lower part of the packaging bag 10 is crushed, a force from the lower part to the upper part of the packaging bag 10 acts on the konjac-containing jelly 5 sealed in the packaging bag 10, and the konjac-containing jelly 5 is pushed out of the opening 18.

At this time, since the opening 18 is formed on the narrow accommodating portion 14, upward movement of the konjac-containing jelly 5 is held back by a leading-out portion 13 of the top seal 22. That is, the leading-out portion 13 functions as an anchor (movement suppressing portion) which suppresses the movement of the konjac-containing jelly 5 to the upper part when the lower part of the packaging bag 10 is crushed.

In the packaging bag 10, the konjac-containing jelly 5 is present as one mass and has unique elasticity derived from konjac. Thus, the konjac-containing jelly 5 is partially compressed toward the narrow accommodating portion 14, while the remaining part is torn off at the boundary between the leading-out portion 13 and the narrow accommodating portion 14 and is pushed out of the opening 18. Since the konjac-containing jelly 5 remains one mass in the accommodating portion 12, it is pushed out of the opening 18 without a part being separated from the packaging bag 10.

As a result, even if the accommodating portion 12 of the opened packaging bag 10 is strongly crushed, a part of the konjac-containing jelly 5 is pushed out of the opening 18 without scattering out of the opening 18. This is because the remaining part of the konjac-containing jelly 5 plays a role of an anchor by being held back by the leading-out portion 13.

The leading-out portion 13 holds back the upward movement of the konjac-containing jelly 5 but does not limit movement in other directions. Thus, when the remaining amount of the konjac-containing jelly 5 in the packaging bag 10 becomes small, the konjac-containing jelly 5 in the vicinity of the leading-out portion 13 can move toward the narrow accommodating portion 14 (opening 18). In the end, all the konjac-containing jelly 5 can be pushed out of the accommodating portion 12.

In order to eat the konjac-containing jelly 5 pushed out of the opening 18, it is needed to be bitten off by teeth. Thus, the konjac-containing jelly 5 pushed out of the packaging bag 10 can be reliably prevented from jumping into the mouth as it is and sticking in the throat. Moreover, since the konjac-containing jelly 5 pushed out of the packaging bag 10 needs to be bitten off, chewiness unique to the konjac-containing jelly can be fully enjoyed.

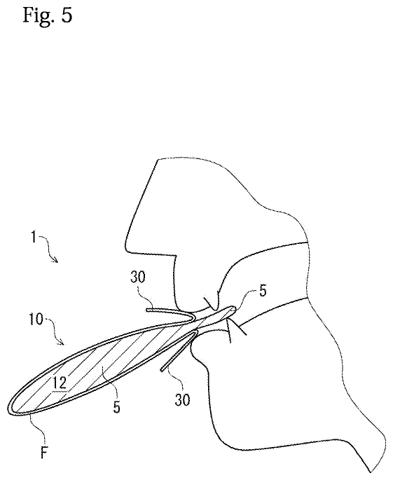

FIG. 5 is a view illustrating a state where a consumer holds the opening 18 in a mouth.

The consumer often holds the opening 18 in the mouth when eating the konjac-containing jelly 5 pushed out of the opening 18. Specifically, the consumer folds down the pair of protruding pieces 30 and brings them into close contact with a surface of the packaging bag 10 (accommodating portion 12). The pair of protruding pieces 30 are folded down so that the inner surfaces thereof face the front surface side and the rear surface side, respectively. Then, the consumer holds the area around the opening 18 of the packaging bag 10 in the mouth. The consumer holds the upper end side of the packaging bag 10 so that the lips of the consumer are brought into contact with a part in which there were the weak seal portion 25 (a surface exposed by peeling off the weak seal portion 25).

At this time, since the lips of the consumer do not contact with an outer surface side of the protruding piece 30 to which dusts, bacteria, or the like can easily adhere, health hazard of the consumer can be prevented. In other words, the inner surfaces of the protruding pieces 30 are not exposed to the outside until the opening 18 is formed, and thus, dusts, bacteria, or the like hardly adheres thereto. Particularly, the area around the opening 18 is a surface which has been exposed by peeling off the weak seal portion 25, and thus, there is no adhesion of dusts, bacteria, or the like. Therefore, the bagged jelly food 1 can prevent health hazard of the consumers by dusts, bacteria, or the like.

### [Variation of Protruding Piece 30]

FIG. 6 are partially enlarged front views illustrating variations of the protruding piece 30 (notches 31 to 33).

As described above, when the pair of protruding pieces 30 have the same shape, they cannot be pinched easily if the protruding pieces 30 are in close contact with each other. Thus, as shown in FIGS. 6, the notches 31 to 33 are provided in the protruding piece 30 on the front side, and tabs 35 to 37 are provided on the protruding piece 30 on the rear side.

The notches 31 to 33 and the tabs 35 to 37 do not overlap even if the protruding pieces 30 are in close contact with each other. By using the notches 31 to 33 and the tabs 35 to 37 (as a starting point), the protruding pieces 30 in close contact with each other can be easily peeled off.

As shown in FIG. 6a for example, the notch 31 with a semicircular shape or the like is provided at a center of the upper end (upper edge) of the protruding piece 30 on the front side, and the tab 35 with a semicircular shape or the like is formed at a center of the upper end (upper edge) of the protruding piece 30 on the rear side.

As shown in FIG. 6b, the notch 32 is provided on the left and right sides of the upper end of the protruding piece 30 on the front side, and the tab 36 is formed on the left and right sides of the upper end of the protruding piece 30 on the rear side.

As shown in FIG. 6c, the notch 33 is provided on the left end of the protruding piece 30 on the front side, and the tab 37 is formed on the left end side of the protruding piece 30 on the rear side.

The notches 31 to 33 are provided on one of the protruding pieces 30 (the protruding piece 30 on the front side), and the tabs 35 to 37 are formed (exposed) on the other protruding piece 30 (the protruding piece 30 on the rear side). As a result, even if the protruding pieces 30 are in close contact with each other, they can be peeled off (separated) easily. Therefore, the consumers can open the packaging bag 10 without any irritation.

The shapes of the notches 31 to 33 and the tabs 35 to 37 can be set arbitrarily.

### [Variation of Peeling Starting Portion]

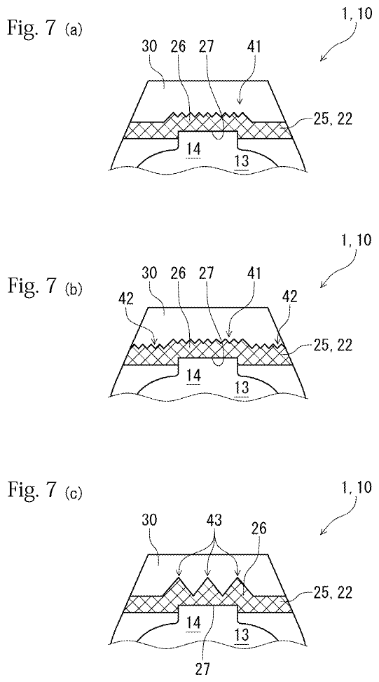

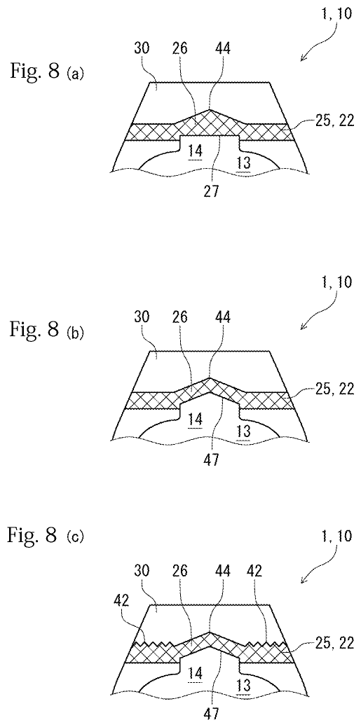

FIGS. 7 and 8 are partially enlarged front views illustrating variations of the peeling starting portion (peeling starting portions 41 to 44). FIG. 8 also illustrates a variation of a concave portion (concave portion 47).

For convenience of explanation, the weak seal portion 25 is hatched in FIGS. 7 and 8.

The peeling starting portions 28 are not necessarily disposed one on each side of the sealed part 26 of the weak seal portion 25.

As shown in FIG. 7a, a peeling starting portion 41 with a zigzag shape may be provided on the upper edge of the sealed part 26. As shown in FIG. 7b, a peeling starting portions 42 with a zigzag shape may be provided not only on the peeling starting portion 41 but also on a part other than the sealed part 26 (both side parts of the weak seal portion 25).

As shown in FIG. 7c, a peeling starting portion 43 with a large zigzag shape may be provided on the sealed part 26. As shown in FIG. 8a, a peeling starting portion 44 may be provided in which the widthwise center of the sealed part 26 is sharpened.

Moreover, as shown in FIG. 8b, the peeling starting portion 44 may be provided on the upper edge of the sealed part 26 while the concave portion 47 is provided along the peeling starting portion 44 on the lower edge of the sealed part 26. In other words, the upper edge and the lower edge (concave portion 47) of the sealed part 26 are formed to have corresponding shapes (parallel profile lines).

Furthermore, the peeling starting portions 41 to 44 and the concave portion 47 may be combined and disposed on the weak seal portion 25. For example, as shown in FIG. 8c, the peeling starting portion 42, the peeling starting portion 44, and the concave portion 47 are disposed.

As described above, by providing the peeling starting portions 28 and 41 to 44 as well as the concave portions 27 and 47 on the weak seal portion 25 (sealed part 26), the weak seal portion 25 can be reliably peeled off in order to form the opening 18.

As described above, in the bagged jelly food 1, the top seal 22 has the pair of strong seal portions 23 protruding from the side seals 21 and the weak seal portion 25 which is in close contact with the upper edges of the pair of strong seal portions 23 in order to seal the upper end side of the narrow accommodating portion 14. The opening 18 from which the narrow accommodating portion 14 is exposed is formed by peeling off the weak seal portion 25.

Since the opening 18 can be formed without cutting off the laminated film F, chemical substances such as an adhesive are not exposed to the opening 18. Therefore, when the konjac-containing jelly 5 is pushed out of the opening 18, there is no possibility that the chemical substances are mixed in the konjac-containing jelly 5.

Moreover, even if the consumers hold the area around the opening 18 in the mouth, the part in contact with the lip is not exposed to the outside until the opening 18 is formed, and thus, the health hazard by bacteria or the like to the consumers can be prevented.

Furthermore, since there is no need to cut off a cut-off piece from the film packaging bag, scattering of plastic waste can be prevented.

The weak seal portion 25 has the concave portions 27 and 47 recessed toward the upper end side with respect to the strong seal portion 23, on the lower edge of the sealed part 26 which seals the narrow accommodating portion 14. As a result, when the weak seal portion 25 is peeled off, the opening 18 is opened wide so that the narrow accommodating portion 14 can be exposed easily.

Since the concave portions 27 and 47 have a shape corresponding to the upper edge of the sealed part 26, the weak seal portion 25 can be reliably peeled off in order to form the opening 18.

The weak seal portion 25 has the peeling starting portions 28 and 41 to 44, which are starting points of the peeling. As a result, the stress can be concentrated even if it is a weak force and thereby the weak seal portion 25 can be peeled off in order to form the opening 18.

Since the peeling starting portion 28 is provided on the center or both sides of the sealed part 26 in the lateral direction, even if the tension (force for peeling the weak seal portion 25) is biased to either the left side or the right side, the weak seal portion 25 can be reliably peeled off in order to form the opening 18.

Since the peeling starting portion 42 is provided on parts on both sides of the sealed part 26, the weak seal portion 25 can be peeled off across the entire length.

The bagged jelly food 1 includes the protruding pieces 30 consisting of the pair of films F extending from the weak seal portion 25. By pinching the pair of protruding pieces 30 with the fingers of both hands and by pulling them in the opposing directions (front-rear direction), the weak seal portion 25 can be peeled off easily.

Since the protruding pieces 30 have a symmetric shape with respect to the sealed part 26, the tensile force is hardly biased to left or right, and the opening 18 can be formed easily.

The present invention is not limited to the aforementioned embodiment but includes those with various modifications added to the aforementioned embodiment within a range not departing from the gist of the present invention. The specific shapes, configurations and the like described in the embodiments are only examples, and modifications can be made as appropriate.

For example, the case in which the packaging bag 10 is substantially a regular square has been shown in the aforementioned embodiments. However, vertical and lateral lengths of the packaging bag 10 are arbitrary. For example, the packaging bag 10 may be vertically longer (the length in the vertical direction is larger than the length in the lateral direction).

The content of the bagged jelly food 1 is not limited to the konjac-containing jelly 5. It may be agar, gelatin, or the like. Moreover, it is not limited to solid food but may be drinking water (liquid). Furthermore, the content is not limited to foods but may be medicals, detergents, pharmaceuticals or the like.

In other words, the content only needs to be the one pushed out of the opening 18 when the lower part of the packaging bag 10 is squeezed (liquid or fluid material). The fluid materials include semi-solid materials such as margarine, shortening, chocolate and the like.

The filling/packaging is not limited to aseptic filling/packaging.

The packaging bag 10 may be a four-sided bag whose lower end in the vertical direction is also heat-welded. Moreover, the packaging bag 10 may be a so-called pillow bag.

The opening 18 (narrow accommodating portion 14) is not necessarily disposed at the center of the packaging bag 10 in the lateral direction. The opening 18 (narrow accommodating portion 14) may disposed on one end side in the lateral direction.

The shapes of the strong seal portion 23 and the weak seal portion 25 can be set arbitrarily in accordance with the shape of the packaging bag 10, the nature of the content, or the like.

The shape of the protruding piece 30 can be also set arbitrarily in accordance with the shape or the like of the weak seal portion 25.

Heat-seal strength of the strong seal portion 23 and the weak seal portion 25 can be set arbitrarily in accordance with the shape of the packaging bag 10, the nature of the content, or the like.

### REFERENCE NUMERALS

1 Bagged Jelly Food (Packaging Bag With Contents)
5 Konjac-Containing Jelly (Content, Fluid Material, Gel-Like Confectionery)
10 Packaging Bag (Film Packaging Bag)
12 Accommodating Portion
13 Leading-Out Portion
14 Narrow Accommodating Portion
18 Opening
21 Side Seal
22 Top Seal
23 Strong Seal Portion
25 Weak Seal Portion
26 Sealed Part
27 Concave Portion
28 Peeling Starting Portion
30 Protruding Piece
31 to 33 Notch (Part That Does Not Overlap)
35 to 37 Tab (Part That Does Not Overlap)
41 to 44 Peeling Starting Portion
47 Concave Portion
F Film

1. A packaging bag with contents obtained by filling a film packaging bag with a fluid and sealing the film packaging bag, comprising:
an accommodating portion in which the fluid is sealed;
a pair of side seals which seal both ends in a lateral direction of the film packaging bag; and
a top seal which seals an upper end side in a vertical direction of the film packaging bag,
wherein the top seal has:
a pair of strong seal portions which connect to each of the side seals and form a narrow accommodating portion communicating with the accommodating portion; and
a weak seal portion which is disposed in close contact with an upper edge of each of the strong seal portions and seals an upper end side of the narrow accommodating portion,
and wherein the weak seal portion is provided with a peeling starting portion, which is a starting point of peeling, and an opening where the narrow accommodating portion is exposed is formed by peeling off the weak seal portion.

2. The packaging bag with contents according to claim 1, wherein the weak seal portion has a concave portion where a lower edge of a sealing part which seals the narrow accommodating portion is recessed toward an upper end side with respect to the upper edge of the strong seal portions.

3. (canceled)

4. (canceled)

5. The packaging bag with contents according to claim 1, wherein the peeling starting portion has a symmetric shape in the lateral direction with respect to the narrow accommodating portion.

6. (canceled)

7. The packaging bag with contents according to claim 1, comprising a pair of protruding pieces which consist of a pair of films extending from the weak seal portion and are pinched when the weak seal portion is peeled off.

8. The packaging bag with contents according to claim 7, wherein the pair of protruding pieces have a symmetric shape in the lateral direction with respect to the narrow accommodating portion.

9. The packaging bag with contents according to claim 7, wherein the pair of protruding pieces have parts not overlapping each other even when the protruding pieces are in close contact.

10. The packaging bag with contents according to claim 1, wherein the strong seal portions form a leading-out portion with a gradually narrowing inner width on the upper end side of the accommodating portion.

11. The packaging bag with contents according to claim 1, wherein the opening is formed at a center of the film packaging bag in the lateral direction.

12. The packaging bag with contents according to claim 1, wherein the fluid is a gel-like confectionery.

13. The packaging bag with contents according to claim 12, wherein the gel-like confectionery is a konjac-containing jelly.

14. The packaging bag with contents according to claim 1, wherein the peeling starting portion is provided on the sealing part which seals the narrow accommodating portion.

15. The packaging bag with contents according to claim 14, wherein the peeling starting portion is also provided on both side parts of the weak seal portion.
